(19) United States
(12) Patent Application Publication
(10) Pub. No.: US 2025/0336400 A1
(43) Pub. Date: Oct. 30, 2025

(54) MANAGING SPEECH USING MODELS

(71) Applicant: GOOGLE LLC, Mountain View, CA (US)

(72) Inventor: Dongeek Shin, San Jose, CA (US)

(21) Appl. No.: 19/190,464

(22) Filed: Apr. 25, 2025

Related U.S. Application Data
(60) Provisional application No. 63/638,654, filed on Apr. 25, 2024.

(51) Int. Cl. G10L 15/25; G10L 15/183; G10L 25/18; G10L 25/57

(52) U.S. Cl. CPC G10L 15/25; G10L 15/183; G10L 25/18; G10L 25/57

(57) ABSTRACT

According to at least one implementation, a method includes obtaining audio data associated with a user, and obtaining video data corresponding to the audio data, the video data from a set of cameras. The method further includes determining features associated with a portion of the user based on the video data and applying a model to the audio data and the features to generate updated audio data, the model configured from second audio data associated with second video data.

### CROSS-REFERENCE TO RELATED APPLICATION

This application claims the benefit of U.S. Provisional Application No. 63/638,654, filed Apr. 25, 2024, the disclosure of which is incorporated herein by reference in its entirety.

### BACKGROUND

Computer systems record audio and video together to capture a complete experience. When both sound and visuals are recorded simultaneously, it creates a richer and more immersive way to document events, communicate, or share information. This is useful in everything from video calls and online classes to movies, vlogs, and surveillance. By collecting both media types, the system can provide more context, detail, and clarity than audio or video alone. This helps users understand not just what is happening but also how it's happening, who is involved, and what the environment is like.

### SUMMARY

This disclosure relates to systems and methods for managing speech using a model and facial data. Specifically, this disclosure relates to systems and methods for managing speech recordings using language models and facial structure data. In some implementations, a system can be configured to capture video data and audio data associated with a presentation from a user. In some examples, the video data corresponds to three-dimensional video data captured from cameras associated with the system. The system can be configured to use a model to generate improved audio data from the video and the audio data. The improved audio data can then be provided with the video data to support the presentation (e.g., video call).

In some aspects, the techniques described herein relate to a method including: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

In some aspects, the techniques described herein relate to a computer-readable storage medium storing executable instructions that, when executed by at least one processor cause at least one processor to execute a method, the method including: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

The accompanying drawings and the description below outline the details of one or more implementations. Other features will be apparent from the description, drawings, and claims.

### BRIEF DESCRIPTION OF THE DRAWINGS

FIG. 1 illustrates an operational scenario of processing and communicating audio and video data according to an implementation.

FIG. 2 illustrates a computing environment that provides improved video and audio capture according to an implementation.

FIG. 3 illustrates a method of operating a computing system to provide improved video and audio capture according to an implementation.

FIG. 4 illustrates an operational scenario of processing audio and video data according to an implementation.

FIG. 5 illustrates an operational scenario of communicating a video stream with updated audio according to an implementation.

FIG. 6 illustrates an operational scenario of feature extraction from three-dimensional imaging according to an implementation.

FIG. 7 illustrates a computing system that provides improved audio and video data according to an implementation.

### DETAILED DESCRIPTION

Computer systems often record audio and video together to provide a more detailed representation of an event or activity. Capturing both elements allows for a more engaging and informative experience, whether for entertainment, communication, education, or security. Video shows what is happening visually, while audio adds depth by including voices, sounds, and/or background noise. Together, they create a more complete and meaningful way to document or share moments, making the content easier to understand and more impactful for the viewer.

Capturing high-quality audio in noisy environments presents several challenges due to unwanted sounds that can interfere with or obscure the desired audio signal. These challenges can significantly affect the clarity, intelligibility, and overall quality of the recorded audio. Some of the primary technical difficulties encountered include background noise, which is any unwanted sound that is not the focus of the recording, signal-to-noise ratio (SNR), which is the ratio of the level of the desired signal to the level of background noise, reverberation and echoes, microphone directionality and/or placement, or other difficulties.

For example, during a video call in a noisy or busy environment, the capturing device may encounter a technical problem in accurately capturing the voice input of the speaking person. The problem is exacerbated when the microphone or microphones are located further away from the person. For example, when recording a person, the microphones can be positioned away from the user so as not to interfere with the user's movement or presentation. This can provide a better experience for the viewer by removing some of the distracting elements (i.e., microphones) but limit the ability to capture audio.

As at least one technical solution, one or more models (e.g., language models) may be combined with facial structure and/or movement data to correct and update a person's voice data. In some implementations, a computing device, such as a computer, augmented reality (AR) device, extended reality (XR) device, or some other device, captures video and audio data associated with one or more users in an environment. The video and audio data are processed using at least a model (e.g., a language model) or large language model (LLM) to correct and enhance the recorded audio data. A model (e.g., LLM) can be a type of artificial intelligence model designed to understand and generate human-like language based on the input it receives.

In some implementations, large language models are, for example, neural network-based models trained on language data, enabling them to learn the intricacies of human language and generate coherent and contextually relevant responses. Here, the responses include improved audio quality based on the received audio input and the received video input by the device. The LLM can be trained based on clean audiovisuals where audio (or language) is known in association with the captured video. This permits the system to effectively identify the user's language based on the movement of the user's mouth in combination with any captured audio from the user.

For example, a user of a computing device uses a video capture application (e.g., video call application, video recording application, and the like) to capture the sentence “the dog ran away,” where the term “away” is obscured because of background noise or undesirable SNR components in the recording. To improve the voice recording, the computing device may deploy a large language model that uses video and voice data to determine what was said by the user and may update the voice recording based on the determination. In updating the voice recording, the computing device may generate an audio representation of the expected audio of the user (e.g., artificial voice) to improve the audio of the recording. Thus, the system may artificially generate and correct the audio rather than miss portions of the user audio to reflect the expected language. The expected language is based on previously identified audio data from the user, the video data (i.e., facial structure data), and the language model.

In some implementations, the large language model is implemented on the device capturing the audio and video data, such as a computer, smartphone, X R device, and the like. In other implementations, the large language model is implemented wholly or partially on a remote device, such as a server or a destination device for a video call. For example, the video and audio data can be synchronized and/or converted to a linear projection and provided to a server that performs the language model using the provided data. The server may then return the updated audio data with the video data to the computing device or may provide or store the updated audio data with the video data in another location.

In some implementations, the system can process the voice and video data using a transformer model. A transformer can improve audio from a video stream by analyzing the sound and visuals together to identify (e.g., understand) the full context of the user's language. It does this by using its attention mechanism to focus on important parts of the audio signal, like speech patterns, and combining that with visual cues, such as lip movements or facial expressions. The transformer's ability to process all this information helps the transformer to determine which parts of the audio are speech and which are noise and/or distortion. The attention mechanism is used to promote or select the most relevant information from the video data (e.g., lip locations) and the audio data. The most relevant information is identified based on the configuration (e.g., training process) that identifies the features that are most relevant to improving or interpreting the voice of the user.

The transformer can be trained to filter out background noise, fill in missing audio, and correct muffled speech by identifying the relationships between sounds, timing, and visuals. For example, if a word is hard to hear but the person's lips form the word “hello,” the transformer can use that visual information to restore or clarify the audio. The transformer layers and multi-head attention allow learning of complex patterns, making the transformer especially good for handling real-world video streams and improving the clarity and quality of the audio.

In some implementations, the system can employ information from multiple cameras and microphones to support the audio correction functionality described herein. Using multiple cameras and microphones can give the system a more reliable understanding of speech in a real-world environment. Multiple microphones allow the system to compare audio from different locations, helping the system isolate the speaker's voice, reduce background noise, and determine where the voice originated. Further, multiple cameras can capture various angles of the speaker's face and body, improving the system's ability to read lips, recognize facial expressions, and interpret gestures. In some examples, multiple cameras can provide three-dimensional (3D) understanding of the user and the user's mouth positioning. This combination of audio and visual information from various sources helps the system enhance speech clarity, fill in missing or distorted audio, and accurately match voices to the correct speaker. The system can use a model that accurately associates the video information (e.g., 3D video features of the user) and captured audio data to improve audio data that reflects the user's intent.

In some implementations, to configure (e.g., train) the model, the system collects paired data of clear audio and 3D video of people speaking captured from various cameras. It aligns the audio with the visual movements of the face (e.g., the lip and jaw motion) at each moment in time. The model then learns patterns between speech sounds and how the speech looks, using this to predict clean, enhanced audio for the captured performance. Over a period of time, the model can improve by reducing the difference between its output and the original clean audio during training. In some implementations, the model can iteratively be enhanced until the difference between the output and the clean audio satisfies at least one criterion (variation in sound waves).

Various embodiments of the present technology provide various technical effects, advantages, and/or improvements to computing systems and components. For example, various examples may include one or more of the following technical effects, advantages, and/or improvements: 1) non-routine and unconventional use of audio and video data to correct missing or compromised audio; and 2) non-routine and unconventional operations using large language models to correct missing or compromised audio.

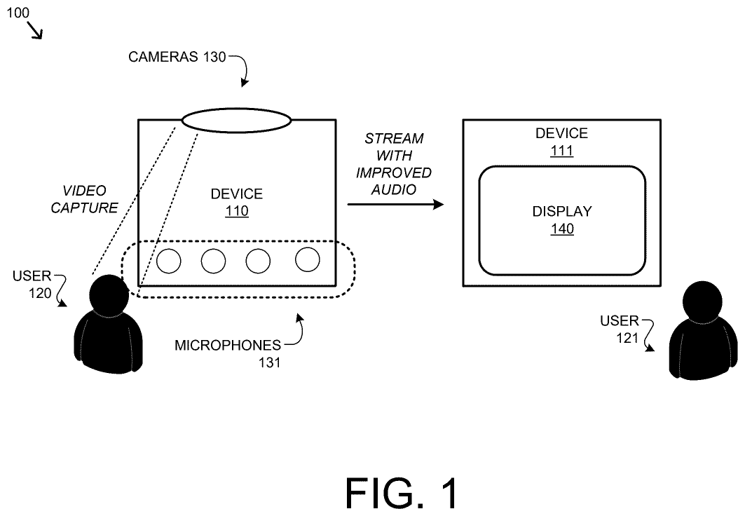

FIG. 1 illustrates an operational scenario 100 of processing and communicating audio and video data according to an implementation. Operational scenario 100 demonstrates the capture of audio and video data at a device 110, processing the audio data to generate improved audio data, and communicating the improved audio data with the video data to a device 111. In some implementations, device 110 and device 111 represent computing devices, such as computers, video communication devices, tablets, or other computing devices.

Operational scenario 100 captures user 120 using cameras 130 and microphones 131, improves the audio using at least one model, and streams the captured video and improved audio to device 111. Device 111 then displays the video via display 140 and provides the improved audio to user 121. In some implementations, in improving the audio, the system implements a model (i.e., transformer model) with a neural network that processes data at the same time using attention mechanisms to understand relationships between elements. In some examples, the model can improve voice audio from user 120 by using both the original sound and 3D images of the speaker's face to enhance speech. The 3D images show how the lips, jaw, or other facial parts move while speaking, which gives helpful visual information about how words are formed. The transformer's attention mechanism can connect the sounds with the matching facial movements, helping the model recognize speech more accurately, even when the audio is noisy and/or missing parts. This combined use of sound and visuals allows the model to clean up the audio, fill in unclear sections, and make the voice sound clear.

For example, during a video presentation in a noisy environment, such as a busy trade show, the model can use the 3D facial images of user 120 to track their mouth movements and match them with the muffled or partially obscured audio. Even if background noise makes it hard to hear certain words, the model can use visual cues to predict what the speaker is saying and enhance those parts of the audio. As a result, user 121 hears a clearer, more accurate version of the speaker's voice despite the noisy surroundings.

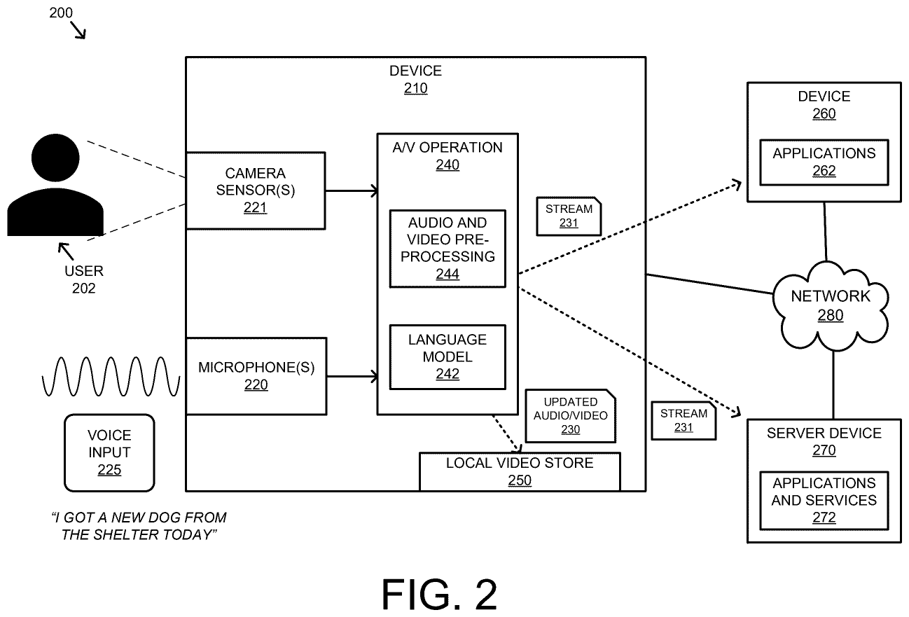

FIG. 2 illustrates a computing environment 200 to provide improved video and audio capture according to an implementation. Computing environment 200 includes user 202, device 210, voice input 225, device 260, server device 270, and network 280. Device 210 further includes camera sensor(s) 221, microphone(s) 220, local video store 250, and audio/video (A/V) operation 240 that provides audio and video pre-processing 244 and language model 242. A/V operation 240 generates updated audio/video 230 and/or stream 231. Device 260 further includes applications 262 that are representative of at least one application capable of receiving stream 231. Device 270 includes applications and service 272 that can receive stream 231 in some examples (e.g., for storage).

In computing environment 200, device 210 captures audio and video data via microphone(s) 220 and camera sensor(s) 221. The audio and video data can be captured as part of a video conferencing application, a video recording application, or another application. The audio and video data are provided to A/V operation 240 for processing to generate updated audio/video 230 (when stored locally) or stream 231 (when communicated to device 260 or server device 270). A/V operation 240 first provides audio and video pre-processing 244, generating linear projections associated with audio and video data. Linear projection is used to transform data from a high-dimensional space to a lower-dimensional space using a linear transformation, aiming to preserve essential structures or properties of the data. This may include transforming important aspects of the speech associated with user 202 in voice input 225 and isolating features captured in the video data from camera sensor(s) 221. Audio and video pre-processing 244 can also be used to synchronize the audio and video data, isolate the portions of the video data associated with the mouth of user 202, provide a spectrogram conversion of the recording, provide a voice-to-text conversion, or provide some other operation in association with the audio data or video data.

In some implementations, A/V operation 240 can be configured to synchronize voice input 225 and the image data associated with camera sensor(s) 221. The voice input 225 and camera data are synchronized to match lip movements and facial expressions accurately to the correct sounds. This timing alignment is essential for improving speech recognition and enhancing audio quality. Once synchronized, voice input 225 and camera data can go through linear projection to convert them into a consistent format for the model (i.e., a transformer model) can understand and work with. These projections map raw features, like sound wave patterns or pixel-based visual data, into vectors of the same size, allowing the transformer to process both data types together. Each vector can be a list of numbers representing something the model needs to understand, like a sound or an image. After linear projection, the audio or video is turned into these number lists so the transformer can compare them, find patterns, and learn how they relate. This step helps the model learn relationships between audio and video more effectively during attention and other computations associated with the model.

After pre-processing the video and audio data from camera sensor(s) 221 and microphone(s) 220, A/V operation 240 implements language model 242. Language model 242 is a computational tool that predicts the likelihood of a sequence of words based on the sequences language model 242 has been trained on. A language model can generate text, complete sentences, or perform tasks like translation and summarization by understanding and processing natural language. Language model 242 may generate updated audio data associated with voice input 225 as a spectrogram. A spectrogram is a visual representation of the spectrum of frequencies of a signal as the spectrum varies with time. A spectrogram is a way to represent how the intensity of different frequencies in a signal changes as a function of time. The updated audio can be fed through a vocoder that provides a time-domain signal to be included with the video data. In some examples, the vocoder can change the spectrogram from the model into natural sounding waveform.

For example, if the background noise limits the audio associated with the term “dog,” A/V operation 240 and language model 242 predict the associated audio from the received audio and video data. The updated audio is then combined with the video data to be provided as a stream 231 to an external device (device 260 or server device 270) or stored as part of local video store 250. In some implementations, A/V operation 240 adds audio, repairs audio, or provides another modification associated with the audio. The audio modification is based on applying a language model to video context (i.e., mouth movement), previously captured audio content, or some other feature.

In some implementations, language model 242 is representative of a transformer model. A transformer model can process audio and video data by converting each into a series of numbers (i.e., vectors) using linear projection and audio and video pre-processing 244. The transformer then uses its attention mechanism to analyze the input, matching visual information like lip movements with the corresponding sounds to identify parts of the audio that may be unclear or distorted. An attention mechanism can help the model focus on the most relevant parts of the input when making decisions. In a transformer model, the mechanism can be configured to compare the various parts of the input to figure out which words, sounds, or visual cues are most relevant at each step, improving understanding and accuracy.

By comparing and aligning the audio and video information, the transformer can identify which parts of the audio need improvement. This combined analysis allows the model to filter out background noise, fill in gaps, and enhance speech clarity, resulting in more accurate and understandable audio. In some implementations, the model can be configured to replace distorted or unclear audio portions. In some implementations, the model can output a spectrogram that can be converted to a time-domain signal using operations such as a vocoder. A vocoder is a tool that converts audio features, like those from user speech, into a realistic-sounding waveform, turning a model's predictions into actual sound. As at least one technical effect, the original audio from the user can be updated to provide a better experience for the viewer. In some examples, the updated audio is communicated with the corresponding video to a second computing device that displays the captured video.

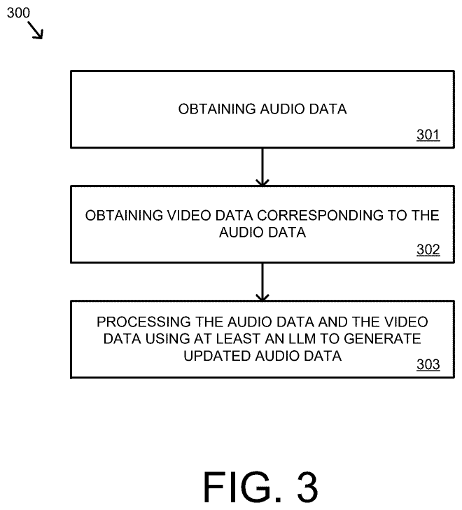

FIG. 3 is a block diagram illustrating method 300 to provide improved video and audio capture according to an implementation. In some examples, method 300 may be performed by device 210 of FIG. 2. In some examples, method 300 can be implemented wholly or partially in a remote computing device, such as a server, a destination device for a video stream, or some other device. For example, method 300 can be performed by a server computer between the presenting device and the receiving device.

Method 300 includes obtaining audio data at step 301 and video data corresponding to the audio data at step 302. In some implementations, the video data is captured using one or more cameras on the device, and the audio data is captured using one or more microphones. In some implementations, the system can synchronize the video and audio data. In some examples, the video and audio data are synched to support the video capture for various applications, including 3D video recording, video calling, or other applications. For example, the device may include multiple cameras to support 3D video calling for a device user. Multiple cameras can be used in a 3D video call by capturing the subject from different angles, allowing the system to reconstruct a 3D view of the person. In some implementations, the cameras can capture the subject from different angles, permitting a viewer to select different angles associated with the presentation.

In some examples, the audio and video data are synced using a shared timestamp or clock that can record the time each portion of data is captured. This allows the system to align sound and visuals frame-by-frame. In some examples, audio-visual cues like lip movements and speech onsets (i.e., moments when speech begins after a period of silence or non-speech) can be matched to improve the synchronization between the audio and video data.

After the audio data and video data are obtained, method 300 further includes processing the audio and video data using at least a model (i.e., language model or LLM) to generate updated audio data at step 303. In some implementations, in processing the video and audio data, the device converts the audio data to a first linear projection and the video data to a second linear projection that are input into the model. Linear projection is a method used to transform data from a high-dimensional space to a lower-dimensional space using a linear transformation, aiming to preserve important structures or properties of the data. Linear projection can convert raw features, such as sound patterns from speech and visual cues from lip movements, into a common format the model can process. This can include taking the different input types and mapping them into vectors of the same size so the transformer can process and compare them effectively. The purpose of linear projection is to compress and focus the input, keeping what helps improve the audio quality of speech while filtering out what is not helpful (noise, small visual details, and the like). For example, linear projection is used to turn video and audio features into vectors of the same size so the features can be compared or combined. This can be used to process the features of the speaker's mouth (e.g., 3D locations of the speaker's lips) to received audio of the speaker.

In some examples, video and audio data are processed to determine features or 3D features associated with a portion of the user captured in the video data. In some implementations, the features comprise 3D physical features related to the movement of the user's mouth. In some implementations, the features are comprised of 3D features related to the movement of the user's face. In some implementations, the features comprise 3D features associated with the movement of the face and mouth. 3D face and mouth features can be identified using images from multiple camera angles to estimate depth and shape. Facial elements like the eyes, nose, and lips are detected in each view and combined to build a 3D model. Computer vision and processing can help improve accuracy and capture detailed expressions. As at least one technical effect, the 3D information from the facial structure derived from the different cameras can provide insight into the words formed by the user. In some implementations, the system can identify features like facial shape, mouth movements, head pose, and the like associated with the speaking user. The features can be extracted from the captured images, including 3D images or representations of the user. For example, the system can identify the location of the edge of the lips and the top of the lips. The locations can be identified using computer vision techniques, like face detection and landmark tracking, to find portions of the user's mouth. Face detection (or mouth detection) can find and locate a face in an image or video. Landmark tracking then identifies points on the face, like the lips, and follows their movements over time. Landmark tracking can further identify various points associated with the lips and face of the user (e.g., the edge of the lips and the top of the lips). The points can be identified in 3D space based on the images associated with the user.

In some implementations, following linear projection, the transformed audio and video features (in the form of values or vectors) can be processed using the operations or layers of the transformer model. The layers can each include an attention portion and a feedforward neural network. The attention portion allows the model to process the data elements from the linearized projection and decide which parts are most important. For example, in processing the video and audio data, the system can compare lip movements to sounds to determine which portions are most useful.

As an illustrative example, each attention head or process can focus on different relationships in the combined data. A first attention process (or head) can align lip movements with speech sounds, helping the model recognize which parts of the video match parts of the received audio. A second attention process can determine timing patterns, such as how long a certain sound or shape lasts. Additional attention processes can identify different elements or relationships associated with the video or audio data. In some implementations, the outputs can comprise a new version of the input that highlights the most relevant parts based on what the model has identified for focus. The attention process can use attention weights to combine and reshape the input so that the result identifies the most helpful information for the task (i.e., improving audio). In some implementations, the attention weights are values or numbers that indicate how important each input or feature is for a particular frame or moment. A higher weight indicates that the system uses that feature more than another. For example, weights can be allocated based on how important the feature is to identify the voice audio, and the weights can be allocated based on the configuration or training of the model. Thus, in some examples, features can be allocated a weight based on the importance of the feature in identifying the speech of the presenter.

In some implementations, the output from the attention process can add back the original input to help preserve information in what is known as a residual connection. The residual connection can be used to preserve the original data and maintain the model's starting point. Once the original input is added, the system can be normalized before moving to the next step of the model (i.e., the feedforward portion). The feedforward portion processes the information from the attention portion at each time step independently (i.e., processes the data for one distinct time period). The feedforward portion applies a set of learned transformations to help the model generate a clearer audio representation, such as a cleaned-up output (e.g., spectrogram). In some implementations, the feed-forward process or network the focused information from attention and transforms it to capture more meaning, like detecting subtle speech patterns, timing, or emotional tone. It uses the patterns and relationships of the most important feature items (identified from the attention process) to determine updated audio from the speaker.

For example, at a specific time step, the audio is noisy or unclear, but the lip movement in the video suggests the person is saying the word “cat.” The attention portion can help the model look at the right parts of the video and the audio to gather this information. Next, the feed-forward network takes that combined information at that moment (i.e., the idea that the sound is unclear, but the lips indicate the person said cat) and processes the information through a neural network. This network doesn't consider other time steps but works with a single time step. The feedforward portion can strengthen the parts of the audio that match the “cat” sound, reduce noise frequencies, or reshape the signal to sound more natural.

In some implementations, the output of the model comprises a spectrogram. A spectrogram is a time-frequency representation of an audio signal. The spectrogram shows how the signal's frequency content evolves, with time on the x-axis, frequency on the y-axis, and the intensity of each frequency represented by color or amplitude values. Spectrograms are widely used in speech and audio processing as they provide a structured way to analyze the temporal and spectral characteristics of sound. The output or spectrogram can be input into a vocoder that converts the audio back to a time-domain waveform. The vocoder reconstructs the audio signal by estimating the phase information and generating a realistic waveform that matches the spectral features. This allows models to produce intelligible and natural-sounding speech from spectrogram outputs. Once converted, the audio signal (i.e., audio data) can be communicated to another device.

In some implementations, to train the model, the system collects paired data of clear audio and 3D video of people speaking. The system aligns the audio with the visual movements of the face, such as lip and jaw motion, at each moment in time. The transformer model then learns patterns between how speech sounds and how it looks, using this to predict clean, enhanced audio from noisy or incomplete input. Over time, it improves by minimizing the difference between its output and the original clean audio during training.

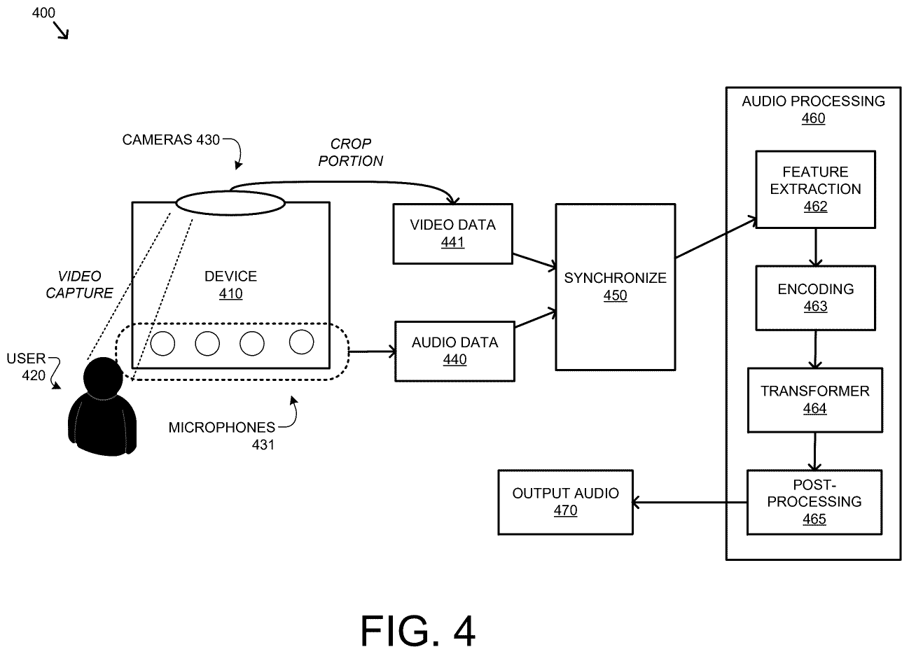

FIG. 4 illustrates an operational scenario 400 of processing audio and video data according to an implementation. Operational scenario 400 includes user 420 and device 410 with cameras 430 and microphones 431. Operational scenario 400 further includes audio data 440, video data 441, synchronize 450, audio processing 460, and output audio 470. Audio processing 460 further includes feature extraction 462, encoding 463, transformer 464, and post-processing 465.

In operational scenario 400, cameras 430 capture video data 441 of user 420. In some examples, video data 441 corresponds to a cropped version of the video data from cameras 430. In some examples, the cropped version corresponds to the mouth or face of user 420. In some implementations, video data 441 can generate a 3D video representation of user 420. In some implementations, cameras 430 include depth cameras and image sensors. In addition to video data 441, microphones 431 capture audio data 440 for user 420. In some examples, microphones 431 includes multiple microphones to identify spatial audio and far-field audio associated with the user.

After receiving video data 441 and audio data 440, operational scenario 400 performs synchronize 450, which can synchronize video data 441 and audio data 440. In some examples, video frames are associated with audio signals for that frame. In some examples, the audio can be synchronized with video by analyzing visual cues like mouth movements and matching them with the timing of the speech sounds. Synchronize 450 can use lip-sync detection or alignment algorithms help ensure the audio lines up with the video data. In some examples, the audio can be sampled in association with each captured frame.

Once synchronized, feature extraction 462 is performed as part of audio processing 460. Feature extraction operations convert raw audio and video data into structured, informative features suitable for model input. For audio, this typically involves computing a spectrogram or mel-spectrogram using short-time Fourier transform (STFT), which captures frequency content over time. Additional operations may include normalization, framing, and applying perceptual filters. For video, feature extraction often includes cropping to focus on the face or lips, converting frames to grayscale or normalized RGB, and using convolutional neural networks (CNNs) or vision transformers to generate frame-wise embeddings that capture lip shape and motion. In some implementations, the features include 3D position features associated with the user's mouth (i.e., lip position in 3D space). The features can be derived from the multi-camera view or the depth cameras. In some implementations, the features include 3D position features associated with the user's face, including cheek or eye structure that can further provide information about the shape of the user's mouth. These extracted features preserve essential temporal and spatial patterns needed for downstream processing by the transformer model.

Following feature extraction 462, the system performs encoding 463. Encoding 463 transforms the extracted features into a form that a model, like transformer 464, can understand and work with. It can include operations like adding positional information, adjusting dimensionality through linear projection, and preparing the data for attention mechanisms. In some examples, encoding can convert things like sound patterns or facial movements into numerical vectors that capture their meaning and structure. This helps the model compare and connect information across time and between audio and visual inputs.

Once encoded, the data is processed using transformer 464. Transformer 464 takes encoded audio and video features and uses attention mechanisms to learn how they relate over time. Transformer 464 identifies which visual cues (like lip movements) help clarify the noisy audio and generates an enhanced audio representation by combining this information through layers of attention and feed-forward processing. Attention can be configured to allow the model focus on the most relevant parts of the audio and video, like matching lip movements to unclear speech sounds. Feed-forward processing transforms that focused information to make the audio clearer at individual instances.

In some implementations, the attention portion of the model can give different importance or weights to parts of the input (features) based on how relevant they are to the model's task. It calculates these weights using vector comparisons and then uses them to combine the most useful information. For example, the attention portion can provide higher attention values to audio segments where the speaker's mouth is moving and lower to audio segments where the speaker's mouth is not moving. When the user's mouth is not moving, the model can assume that no voice audio is present.

After being processed via transformer 464, post-processing 465 is applied to generate output audio. Post-processing 465 can convert the enhanced audio representation (such as a spectrogram) back into a waveform that can be played or listened to. This is done using techniques such as inverse short-time Fourier transform or vocoders that generate natural-sounding speech.

For an example of using operational scenario 400, a noisy video of a person speaking is processed to enhance the audio using both the sound and the visual cues. First, feature extraction 462 converts the raw audio into a spectrogram and the video into lip movement embeddings. These features are then encoded via encoding 463 with positional and dimensional adjustments to prepare them for the transformer model. Transformer 464 then uses attention to match lip movements with unclear parts of the audio and feed-forward layers to refine that information, producing a cleaner audio representation. Post-processing 465 converts this enhanced spectrogram back into a clearer speech waveform. The technical effect, especially in far-field audio, is correcting distorted or missing audio.

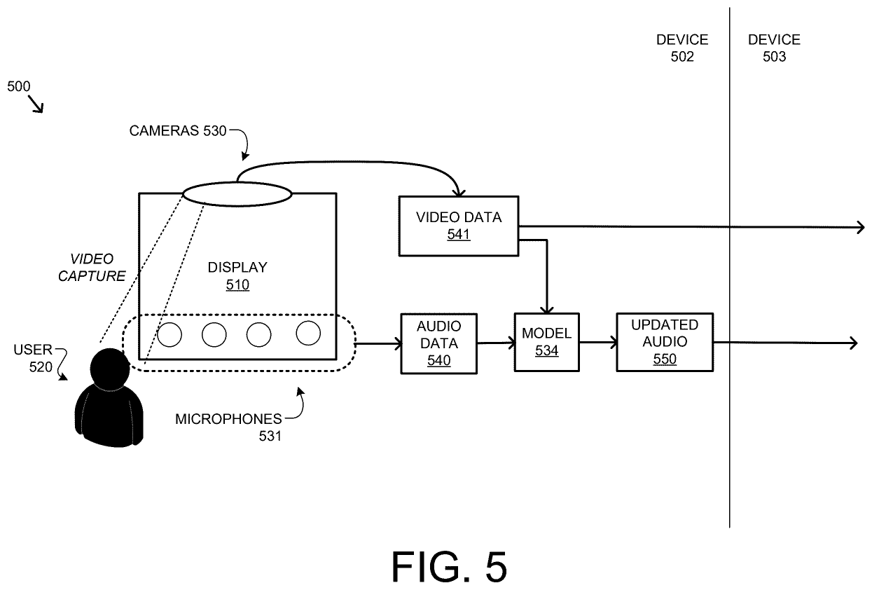

FIG. 5 illustrates an operational scenario 500 of communicating a video stream with updated audio according to an implementation. Operational scenario 500 includes display 510, user 520, cameras 530, microphones 531, audio data 540, video data 541, model 534, and updated audio 550. The steps of operational scenario 500 are used to improve audio quality at device 502 prior to communicating audio to device 503.

In operational scenario 500, video data 541 is captured via cameras 530 and audio data 540 is captured via microphones 531. In some implementations, multiple cameras 530 are placed around user 520 to capture their appearance and movements from different angles, allowing the system to reconstruct a 3D model of at least a portion of their body (e.g., face). Further, multiple microphones 531 can record sound from different positions to estimate the user's voice location and improve audio clarity. Together, these inputs can create a 3D presentation of the user in both video and sound. However, a technical problem can exist in accurately recording audio data in far-field situations (sound recorded from one or more microphones placed further away from a speaker).

To improve the audio quality, model 534 is included that processes audio data 540 and video data 541 to generate updated audio 550. In some implementations, model 534 can improve audio data 540 by using the 3D video data 541 of user 520 to track detailed facial and lip movements, which provide visual cues about what is being said. These visual signals (or features) help the model detect speech content even when the audio is noisy or unclear. By combining the temporal and spatial features from both the audio and 3D video, the model learns to enhance or reconstruct the clean speech signal with greater accuracy. Once updated audio 550 is generated, updated audio 550 and video data 541 can be communicated from device 502 to device 503. In some implementations, 3D position features of user 520 that can help improve audio include the 3D coordinates of the mouth, jaw, and lip contours, which show how the mouth opens, closes, and shapes during speech. In some examples, the features can further include head or face position and orientation to provide context where the audio is coming from. The features can further include depth maps and point clouds associated with a user's face in some examples.

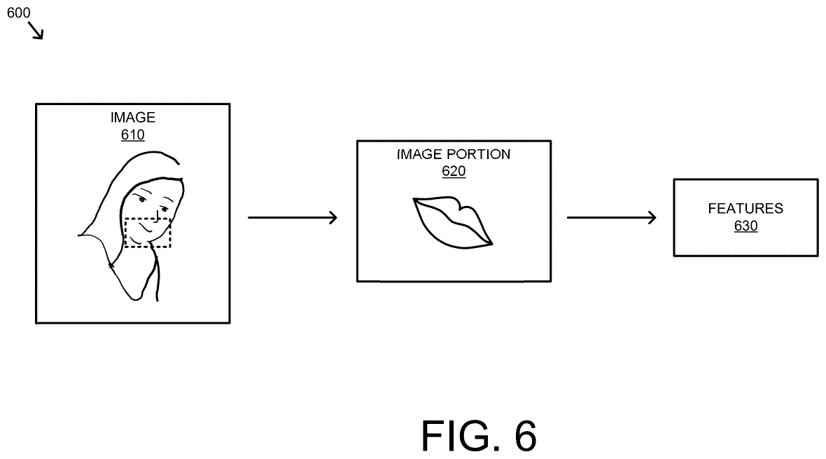

FIG. 6 illustrates an operational scenario 600 of feature extraction from 3D imaging according to an implementation. Operational scenario 600 includes image 610, image portion 620, and features 630.

In operational scenario 600 a system can include cameras that capture images of a subject (i.e., user). As the images are captured, relevant portions of the images can be cropped or identified. In some implementations, the system can crop images of a certain portion of a user by first detecting key landmarks, such as the face, eyes, or mouth, using computer vision models like face or pose detectors. Once the target region (e.g., mouth) is identified, the system calculates a bounding box around the region and crops that area from the video frames.

In the example of operational scenario 600, the system captures image 610 and extracts image portion 620. The system then identifies features 630 associated with image portion 620 or images in some examples. In some implementations, the features correspond to 3D positional features associated with the user. The 3D positional features can include features about the user's face and/or mouth. In some implementations, the system can identify features such as facial landmarks, depth maps, and surface geometry of the mouth and surrounding areas. In some implementations, the features include the 3D positions and movements of the lips, jaw, and cheeks, which provide detailed visual cues about speech articulation. Depth information allows the system to isolate the speaker from the background and accurately track their face and mouth in 3D space.

In some implementations, to identify 3D features from camera input, the system uses multiple camera views or depth-sensing cameras to capture spatial information about the user's face and movements. Computer vision techniques, such as 3D facial landmark detection or stereo image reconstruction, are applied to extract key points around the mouth, jaw, and facial contours. These points are tracked over time to generate 3D trajectories that reflect speech-related motion. Depth maps or point clouds may also be used to estimate the distance of each facial region from the camera, enabling accurate modeling of facial geometry.

After the features are identified, the system can implement a transformer model to improve the speech of the user. In some examples, the features can be used by providing visual context that complements the audio input. The 3D features, including movements, jaw motion, and facial depth, are encoded as sequences of vectors and aligned in time with audio features like spectrogram frames. The transformer uses attention mechanisms to learn how specific visual patterns (e.g., lip shapes) relate to speech content. By combining these visual and audio cues through cross-modal attention and feed-forward processing, the model generates a cleaner audio representation that more accurately reflects the intended speech.

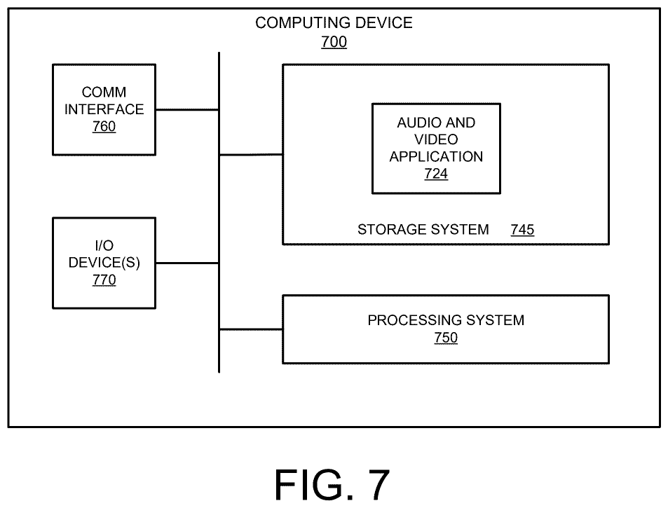

FIG. 7 illustrates a computing system 700 that provides improved audio and video data according to an implementation. Computing system 700 is representative of any computing system or systems with which the various operational architectures, processes, scenarios, and sequences disclosed herein for a computing device can be implemented. Computing system 700 is an example of device 110 of FIG. 1 or device 210 of FIG. 2, although other examples may exist. Computing system 700 includes storage system 745, processing system 750, communication interface 760, input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format-including combinations thereof. Communication interface 760 may be configured to communicate with external devices, such as servers, user devices, or some other computing device. In some implementations, communication interface 760 can communicate with a second computing device, such as a device viewing a presentation.

I/O device(s) 770 may include peripherals of a computer that facilitate the interaction between the user and computing system 700. Examples of I/O device(s) 770 may include keyboards, mice, trackpads, monitors, displays, printers, cameras, microphones, external storage devices, and the like. In some implementations, one or more cameras are used to capture video data associated with a user, the video data including at least mouth movement information for the user. In some implementations, one or more microphones receive audio data associated with a user to facilitate video recordings, video calls, and the like in conjunction with the recorded video data.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media (also referred to as computer readable storage media) include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises audio and video application 724. The operating software on storage system 745 may further include an operating system, utilities, drivers, network interfaces, applications, or some other type of software. When read and executed by processing system 750 the operating software on storage system 745 directs computing system 700 to provide at least method 300 described in FIG. 3.

In some implementations, audio and video application 724, when read and executed by processing system 750, directs processing system 750 to obtain audio data associated with a user and video data corresponding to the audio data. In some implementations, the video data is obtained from a set of cameras. In some implementations, the video data is captured to provide a 3D presentation of a user. For example, multiple cameras can be employed to generate 3D video associated with a user. The cameras can include imaging cameras and depth cameras, for example.

In some implementations, audio and video application 724 further directs processing system 750 to determine features associated with a portion of the user based on the video data. In some examples, portions of the video data are cropped to include body elements related to a presenter's speech. In some examples, the cropping includes the presenter's face. In some examples, the cropping consists of the presenter's mouth. In some implementations, computing system 700 can track how the presenter's face moves, including the lips, jaw, and mouth. The system can determine the 3D location of the movements based on different angles and identify relevant features associated with the user's speech. In some examples, the video data is provided by stereo, depth, structured light, or other cameras. The camera information can be used to derive the 3D location of relevant elements like the user's mouth and face. In some examples, the system can use face detection algorithms to find the location of the face in the image. Then, the system applies facial landmark detection to identify and isolate the mouth and other key regions for analysis.

In some implementations, audio and video application 724 further directs processing system 750 to apply a model to the audio data and the features to generate updated audio data, the model configured from second audio data associated with second video data. In some examples, the model includes a transformer model. A transformer model can improve audio by using both the sound and visual cues from the speaker, such as 3D images of their face. The transformer looks at how the mouth and face move while talking and matches those movements with the audio to better understand what is being said. If the audio is noisy, unclear, or missing parts, the model can use the visual information to guess the correct sounds and fill in gaps. The transformer can also reduce background noise and make the voice sound clear and natural. As a technical effect, this helps listeners better understand the speaker, especially in poor audio conditions like video calls or crowded places. Examples of these conditions can include far-field audio conditions where the microphones are not located near the user.

In some implementations, a large dataset of paired audio and 3D video recordings of people speaking is used to train the model. Each video frame is aligned with the corresponding audio to match speech sounds with facial movements like lip shapes, jaw positions, and other visual cues. During training, the system performs feature extraction to pull important information from the audio (such as pitch and timing) and the video (such as mouth and face movements). These features are then encoded into numerical representations and fed into the transformer model. The model learns to use attention mechanisms to understand how the visual and audio features relate over time and how they contribute to clear speech. The model is configured or trained to predict clean, high-quality audio by comparing its output to the original clean audio and adjusting its internal weights to reduce the difference. Over many examples, the model improves its ability to enhance noisy or incomplete audio using the combined visual and audio information.

Example clauses are provided below. Although these are examples, these clauses should not be considered exhaustive.

Clause 1. A method comprising: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

Clause 2. The method of clause 1, wherein the audio data comprises first audio data from a first microphone and second audio data from a second microphone.

Clause 3. The method of clause 1, wherein the portion comprises a mouth and the features include three-dimensional position features associated with the mouth.

Clause 4. The method of clause 1, wherein the portion comprises a face and wherein the features include three-dimensional position features associated with the face.

Clause 5. The method of clause 1, wherein the video data comprises three-dimensional video data, and wherein at least one camera in the set of cameras comprises a depth camera.

Clause 6. The method of clause 1, wherein applying the model to the audio data and the features to generate the updated audio data comprises: generating a spectrogram based on an application of the model to the audio data and the features; and generating the updated audio data based on the spectrogram and a vocoder.

Clause 7. The method of clause 1 further comprising: communicating at least a portion of the video data with the updated audio data to a computing device.

Clause 8. The method of clause 1, wherein the model comprises a transformer model.

Clause 9. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

Clause 10. The computing system of clause 9, wherein the audio data comprises first audio data from a first microphone and second audio data from a second microphone.

Clause 11. The computing system of clause 9, wherein the portion comprises a mouth and wherein the features include three-dimensional position features associated with the mouth.

Clause 12. The computing system of clause 9, wherein the portion comprises a face and wherein the features include three-dimensional position features associated with the face.

Clause 13. The computing system of clause 9, wherein the video data comprises three-dimensional video data, and wherein at least one camera in the set of cameras comprises a depth camera.

Clause 14. The computing system of clause 9, wherein applying the model to the audio data and the features to generate the updated audio data comprises: generating a spectrogram based on an application of the model to the audio data and the features; and generating the updated audio data based on the spectrogram and a vocoder.

Clause 15. The computing system of clause 9, wherein the method further comprises: communicating at least a portion of the video data with the updated audio data to a computing device.

Clause 16. The computing system of clause 9, wherein the model comprises a transformer model.

Clause 17. A computer-readable storage medium storing executable instructions that, when executed by at least one processor cause at least one processor to execute a method, the method comprising: obtaining audio data associated with a user; obtaining video data corresponding to the audio data, the video data from a set of cameras; determining features associated with a portion of the user based on the video data; and applying a model to the audio data and the features to generate updated audio data, the model configured from second audio data associated with second video data.

Clause 18. The computer-readable storage medium of clause 17, wherein the portion comprises a mouth and the features include three-dimensional position features associated with the mouth.

Clause 19. The computer-readable storage medium of clause 17, wherein the portion comprises a face and wherein the features include three-dimensional position features associated with the face.

Clause 20. The computer-readable storage medium of clause 17, wherein the video data comprises three-dimensional video data, and wherein at least one camera in the set of cameras comprises a depth camera.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, no intervening elements are present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
obtaining audio data associated with a user;
obtaining video data corresponding to the audio data, the video data from a set of cameras;
determining features associated with a portion of the user based on the video data; and
applying a model to the audio data and the features to generate updated audio data, the model configured from second audio data associated with second video data.

2. The method of claim 1, wherein the audio data comprises first audio data from a first microphone and second audio data from a second microphone.

3. The method of claim 1, wherein the portion comprises a mouth and the features include three-dimensional position features associated with the mouth.

4. The method of claim 1, wherein the portion comprises a face and wherein the features include three-dimensional position features associated with the face.

5. The method of claim 1, wherein the video data comprises three-dimensional video data, and wherein at least one camera in the set of cameras comprises a depth camera.

6. The method of claim 1, wherein applying the model to the audio data and the features to generate the updated audio data comprises:
generating a spectrogram based on an application of the model to the audio data and the features; and
generating the updated audio data based on the spectrogram and a vocoder.

7. The method of claim 1 further comprising:
communicating at least a portion of the video data with the updated audio data to a computing device.

8. The method of claim 1, wherein the model comprises a transformer model.

9. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
obtaining audio data associated with a user;
obtaining video data corresponding to the audio data, the video data from a set of cameras;
determining features associated with a portion of the user based on the video data; and
applying a model to the audio data and the features to generate updated audio data, the model configured from second audio data associated with second video data.

10. The computing system of claim 9, wherein the audio data comprises first audio data from a first microphone and second audio data from a second microphone.

11. The computing system of claim 9, wherein the portion comprises a mouth and wherein the features include three-dimensional position features associated with the mouth.

12. The computing system of claim 9, wherein the portion comprises a face and wherein the features include three-dimensional position features associated with the face.

13. The computing system of claim 9, wherein the video data comprises three-dimensional video data, and wherein at least one camera in the set of cameras comprises a depth camera.

14. The computing system of claim 9, wherein applying the model to the audio data and the features to generate the updated audio data comprises:
generating a spectrogram based on an application of the model to the audio data and the features; and
generating the updated audio data based on the spectrogram and a vocoder.

15. The computing system of claim 9, wherein the method further comprises:
communicating at least a portion of the video data with the updated audio data to a computing device.

16. The computing system of claim 9, wherein the model comprises a transformer model.

17. A computer-readable storage medium storing executable instructions that, when executed by at least one processor cause at least one processor to execute a method, the method comprising:
obtaining audio data associated with a user;
obtaining video data corresponding to the audio data, the video data from a set of cameras;
determining features associated with a portion of the user based on the video data; and
applying a model to the audio data and the features to generate updated audio data, the model configured from second audio data associated with second video data.

18. The computer-readable storage medium of claim 17, wherein the portion comprises a mouth and the features include three-dimensional position features associated with the mouth.

19. The computer-readable storage medium of claim 17, wherein the portion comprises a face and wherein the features include three-dimensional position features associated with the face.

20. The computer-readable storage medium of claim 17, wherein the video data comprises three-dimensional video data, and wherein at least one camera in the set of cameras comprises a depth camera.
